(19) United States
(12) Patent Application Publication
(10) Pub. No.: US 2012/0022920 A1
(43) Pub. Date: Jan. 26, 2012

(54) ELICITING CUSTOMER PREFERENCE FROM PURCHASING BEHAVIOR SURVEYS

(75) Inventors: Filippo Balestrieri, Mountain View, CA (US); Sundar Rajaram, Mountain View, CA (US); Julie Ward Drew, Redwood City, CA (US); Enis Kayis, East Palo Alto, CA (US)

(73) Assignee: Hewlett-Packard Development Company, L.P., Houston, TX (US)

(21) Appl. No.: 13/260,258

(22) PCT Filed: Feb. 26, 2010
(86) PCT No.: PCT/US10/25601

§ 371 Date: Sep. 24, 2011

(51) Int. Cl. G06Q 30/02

(52) U.S. Cl. 705/7.32

(57) ABSTRACT

A method (200) of eliciting customer preference from purchasing behavior surveys clusters (210) survey respondents into two or more clusters according to a data pattern identified in a dataset (330) of responses to survey questions that include a question regarding a product purchasing decision, and questions regarding respondent attributes (such as behavioral questions) and product attributes. Clustering (210) may be performed based on responses to behavioral questions that are not endogenously linked to any control variables. A model for each cluster, relating purchasing decision responses to product attribute responses, is produced (220), and each model is used to generate (230) projected purchasing decision responses for each cluster by replacing a value relating to a response to a selected product attribute question, which may be a control variable, with an alternative value. The dataset is transformed (240) by replacing purchasing decision responses with the projected responses. Survey respondents are then re-clustered (250), and duster shift is analyzed (260).

### BACKGROUND

Past purchasing behavior may be a noisy signal of customer preferences. Several other factors, for example personal income, product price, and so forth, may influence purchasing decisions, either in coordination with or independent of personal preferences, as exhibited by past purchasing behavior. For example, different product prices may lead to different purchasing trends, even when a customer's latent preferences remain the same. When data regarding past purchasing behavior are used, for example by a market manager to perform a market segmentation analysis over preferences, it may be important to isolate the impact of one or more of these other factors on purchasing decisions. It may be of particular importance to isolate the effect of factors that relate to variables that may be controlled, such as product price.

Impact attributable to such factors is sometimes addressed by solutions that attempt to account for sampling bias, such as by weighting survey respondents. In such an approach, weights are typically set in a manner that standard population benchmarks are met. However, such approaches do not isolate the noise in customer purchasing choices.

### BRIEF DESCRIPTION OF THE DRAWINGS

FIG. 1 illustrates an example process associated with eliciting customer preferences from purchasing behavior surveys, in accordance with an embodiment of the invention.

FIG. 2 illustrates an example method of eliciting customer preferences from purchasing behavior surveys, in accordance with an embodiment of the invention.

FIG. 3 illustrates an example system and apparatus associated with eliciting customer preferences from purchasing behavior surveys, in accordance with an embodiment of the invention.

### DETAILED DESCRIPTION

Methods of eliciting customer preference from purchasing behavior surveys consider survey data that includes purchasing choices for particular products, along with customer demographic and behavioral data. In an example method, survey respondents are clustered according to their answers to questions that are not related to purchasing choices, to identify similar behavioral patterns. At a cluster-specific level, a regression model is built that relates purchasing decision responses to selected customer attributes and product attributes. Projected purchasing decisions are generated, using the model, by replacing a value representing a response to a selected product attribute question with an alternative value. The replaced value may be a control variable; for example, the selected product attribute question may relate to the price paid for a product, such that replacing the values that represent the responses to the question may project purchasing decisions of the cluster population, if the product price is changed.

The dataset of survey responses may be transformed by replacing purchasing decision data with the projected purchasing data from the clusters considered. The survey respondents may be re-clustered, for example according to a data pattern in a selected subset of responses that exclude those related to control variables. The cluster shift may be assessed to distinguish preference-driven purchasing behaviors from those purchasing behaviors attributable to variables associated with the alternative values, for example, product price.

A system of eliciting customer preference from purchasing behavior surveys may include data storage subsystem configured to store such a dataset. The system may further include a processing subsystem in communication with the data storage subsystem that is configured to perform various steps of the methods of workforce plan evaluation described herein.

An apparatus, for example, a computer, which may include one or more computers and/or a computer network, for eliciting customer preference from purchasing behavior surveys may use such a dataset, which may be stored in a memory or memory device. The apparatus may incorporate a clustering module that clusters survey respondents according to a selected data pattern in the dataset, such as a data pattern representing responses to survey questions that include a question regarding a product purchasing decision, and questions regarding respondent attributes and product attributes. The apparatus also may include a model producer that produces, from data associated with a given cluster, a model relating purchasing decision responses to product attribute responses. The apparatus further may include a generator that uses the model to generate projected purchasing decision responses for the cluster, such as by replacing a value relating to a response to a selected product attribute question that relates to a control variable with an alternative value that relates to a predetermined value of the control variable. The apparatus may further include a data transformer that transforms the dataset by replacing purchasing decision responses with the projected responses. The apparatus may further incorporate a re-clustering module that re-clusters survey respondents according to a selected data pattern in the transformed dataset.

These principles are discussed herein with respect to example processes, methods, system, and apparatus, and with reference to various diagrams. The example embodiments are shown and described as a series of blocks, but are not limited by this depiction, as the actions, steps, concepts, and principles associated with the illustrated blocks may occur in different orders than as described, and/or concurrently, and fewer or more than the illustrated number of blocks may be used to implement an example method. Blocks may be combined or include multiple components or steps.

The functional units described herein as steps, methods, processes, systems, subsystems, routines, modules, and so forth, may be implemented by one or more processors executing software. Executable code may include physical and/or logical blocks of computer instructions that may be organized as a procedure, function, and so forth. The executables associated with an identified process or method need not be physically collocated, but may include disparate instructions stored in different locations which, when joined together, collectively perform the method and/or achieve the purpose thereof. Executable code may be a single instruction or many, may be distributed across several different code segments, among different programs, across several memory devices, and so forth. Methods may be implemented on a computer, with the term “computer” referring herein to one or more computers and/or a computer network, or otherwise in hardware, a combination of hardware and software, and so forth.

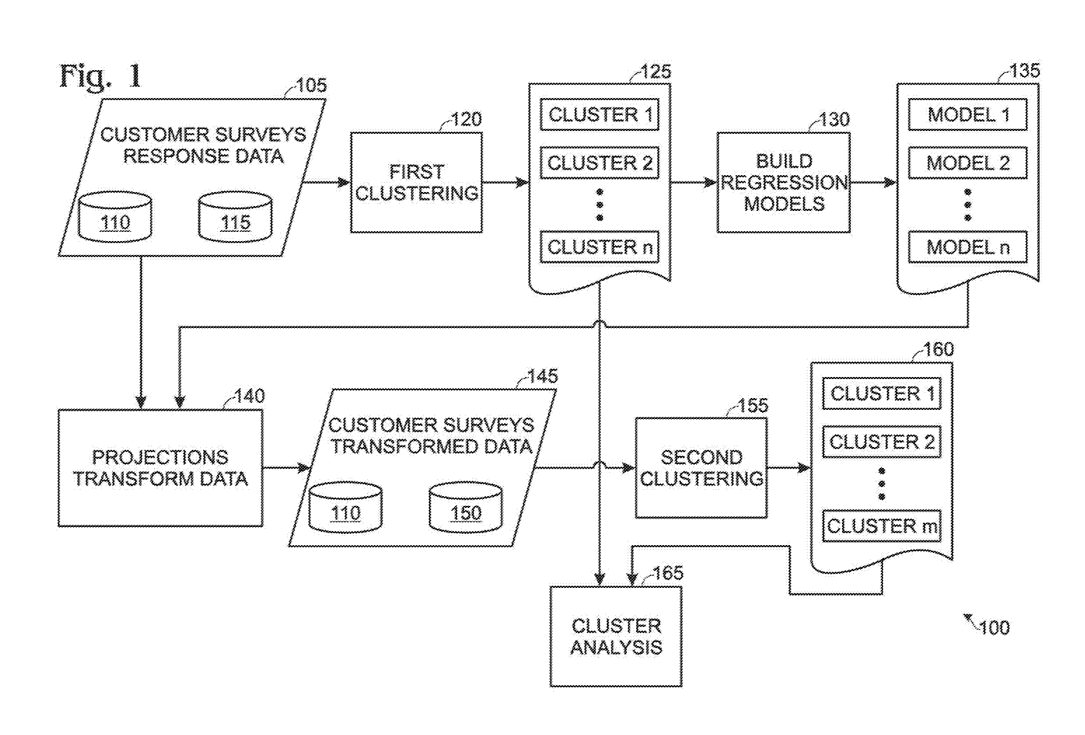

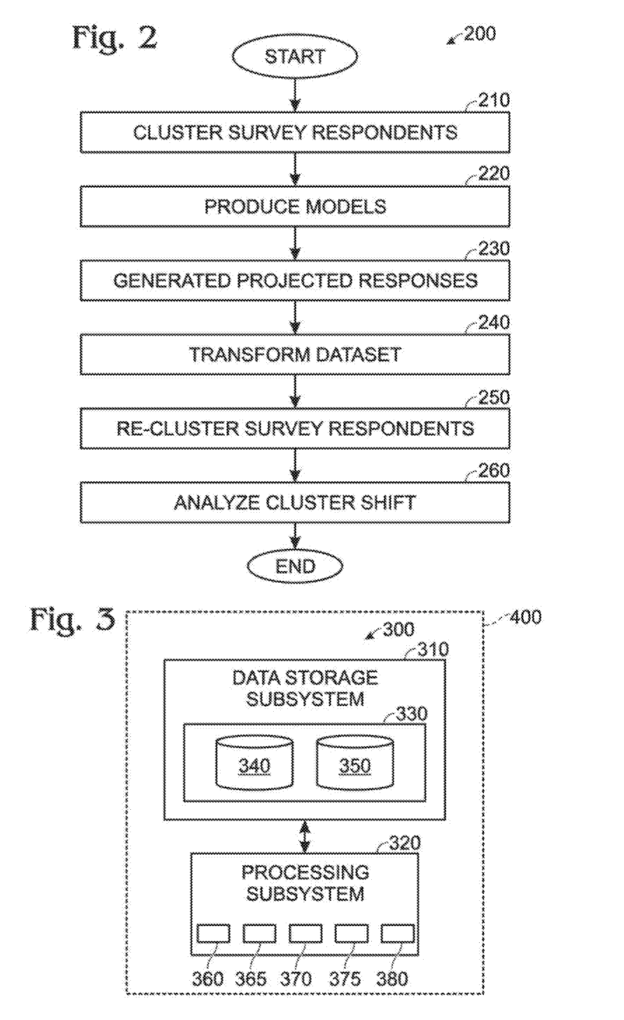

FIG. 1 illustrates an example data analysis process 100 associated with eliciting customer preferences from purchasing behavior surveys. The example process includes representations of data considered in the process, as well as various actions that are performed as part of a method, such as the example method 200 of eliciting customer preferences from purchasing behavior surveys illustrated in FIG. 2. Example process 100 and example method 200 may be executed on a computer. For example, the method and/or process may be stored as logic encoded on a computer readable medium which, when executed by a processor, implements the method and/or process. The data analysis process 100 may take place as part of an example system 300, as illustrated in FIG. 3, and/or within or by an apparatus 400, such as a computer.

In FIG. 1, a dataset including one or more customer surveys, and survey response data, such as from purchasing behavior survey questions, is shown at box 105. Some methods may be performed using existing survey data, whereas some methods may include compiling surveys directed to purchasing behavior. Purchasing behavior surveys may be compiled and administered for various reasons, such as to test the market for a particular product or product type. Customer survey questions, the responses thereto, and the data representing such responses, may be classified generally as belonging to one of two categories, those relating to a product or a product type, and those relating to the respondent, or customer. The latter type may include demographic questions and/or behavioral questions. Demographic questions may include such questions as “How old are you?”, whereas behavioral questions may include such questions as:

“Do you play sports?”,

“Do you read books?”,

“Do you watch TV?”,

“What kind of TV programs do you usually watch?”,

and so forth.

For the sake of illustration, the various concepts discussed herein are described with respect to an example software product such as a computer video game. In this example, product-related questions may include such questions as:

“Do you scan files for viruses?”,

“Do you play music files on your computer?”,

“Do you buy computer games?”,

“How much do you usually pay for computer games?”,

and so forth.

One type of product-related question is a question relating to the respondent's purchasing decision for a product or product type, such as “Do you buy product X?” In this example, the “Do you buy computer games?” question is a product purchasing decision question.

Some of the product-related questions may relate to variables under control of a marketer, such as product price. As such, in this example, the “How much do you usually pay for computer games?” question relates to a control variable.

The customer survey response data indicated at box 105 may be referred to based on the type of question to which the responses are given. As such, the response data may include product attribute data (or product attribute responses), and respondent attribute data (or respondent attribute responses). These data subsets are indicated in FIG. 1 at 110 and 115, respectively. Product attribute data may further include purchasing decision data (or purchasing decision responses).

The survey response data may express survey responses as numerical values. For example, responses to yes/no questions may be assigned “1” and “0” values, respectively, whereas responses to multiple choice questions may be expressed by a value relating to the options provided as possible answers to the question. For example, the “What kind of TV programs do you usually watch?” question may have three possible answers (e.g., “Sports”, “Documentaries”, and “Movies”), which may be mapped to numerical values such as “1”, “2”, and “3”.

At 120, survey respondents are clustered, or identified as being members of different populations, based on a data pattern identified in the customer survey response data, such as a data pattern in the respondent attribute data 110. The data pattern may relate to responses to one or more selected behavioral questions; for example, the data pattern may be a number of identical responses to a selected behavioral question.

Some embodiments may include identifying the data pattern, such as by a market analyst, in which the question (or questions) used for clustering are selected from among those that are not associated with variables that are endogenously linked to purchasing decisions. As used herein, the term “endogenous” is used to refer to a variable in a system that is determined by the system itself. Such a variable may be thought of as “endogenously linked” to one or more parts of the system. To illustrate using the example of computer video game software, the behavioral question “What kind of TV programs do you usually watch?” may be associated with a variable representing TV program type. The question is not used for clustering if the responses to the question (TV program type) depend on what type of software the respondent purchases. However, the question may be used for clustering if what type of software the respondent purchases depends on the type of TV program the respondent watches. If a variable is not endogenous to a system, or in other words if no endogenous link exists between the variable and any part of the system, it may be referred to as “exogenous” or “non-endogenous.” Whether or not an endogenous link exists may be determined from the question itself, or from responses to other survey questions directed at indicating the presence (or absence) of such a relationship. In embodiments that involve compiling customer surveys, a subset of questions may be directed to identifying endogenous variables in the survey data.

Different kinds of clustering are possible. In some examples, respondents are each associated with exactly one of a plurality of mutually exclusive clusters, a practice sometimes referred to as “hard clustering.” In some examples, some respondents may be associated with a probability distribution across a plurality of clusters that may not be mutually exclusive, a practice sometimes referred to as “soft clustering.” For example, if the analysis identifies two clusters based on the question “What kind of TV programs do you usually watch?” that are labeled, for example “Sports Fan” and “Movie Fan,” in hard clustering, the population of survey respondents is divided into two groups. In soft clustering, each survey respondent belongs to each cluster with some probability. In either approach, the output of the clustering process is shown at 125 as a set of clusters 1, 2, . . . n.

At 130, a model that relates purchasing decision responses to respondent and product attribute responses is produced, for example by a computer, for each of the clusters. In producing the model, the clusters 1, 2, . . . n, are treated as different populations. In hard clustering, the survey respondents are grouped into different populations. In soft clustering, each cluster corresponds to a fictitious population. More particularly, in soft clustering, each real-life respondent is represented by a fictitious population of several clones. The higher the probability that the real-life respondent belongs to a certain cluster, the higher the number of his clones that are assigned to that cluster.

Given the populations, the example process proceeds by building a regression model for each. In general, the regression model may be represented as:

yᵢ=βX+ε

Each vector yᵢ represents the purchasing decision regarding the product i. Element y_{i,j} of vector yᵢ is a 0-1 variable corresponding to how respondent j answered the purchasing decision question. In the computer video game example, a “yes” answer to the question “Do you buy computer games?” corresponds to a value of 1, whereas a “no” answer is registered as 0.

In the model, X is a matrix consisting of elements x_{j,k}, each representing respondent j's answer to question k. Each row vector is respondent j's answer to all questions considered, and each column vector is the collection of all responses to each question k. In some embodiments, the questions considered for the matrix include demographic questions and product attribute questions. In the illustrative example setting, these questions may include:

“How old are you?”,

“What kind of computer do you have?”,

“Where did you buy your computer?”,

“How much do you usually pay for computer games?”,

and so forth.

Finally, ε represents stochastic error, and β is a vector of unknown parameters. Because the purchasing question involves a choice between two discrete alternatives (i.e., yes or no), the model may be a type of a binary choice model. The regression model for each cluster relates the respondent's purchasing decision responses to product attribute questions, in some cases together with demographic data.

The formula for estimating β (e.g., by calculating the estimator β) may depend on the assumptions about the distribution of error E. For example, one assumption is that ε is distributed given X according to a uniform distribution, in which case the binary choice model is a linear probability model. Another approach may assume that α is distributed according to a standard normal, in which case the model is a probit model. Another approach may assume ε is distributed according to a logistic function, in which case the model is a logit model. The type of model may in turn determine the manner in which the estimator β′ is calculated. For example, in probit and logit models, the estimator may be calculated through a maximum likelihood estimation (“MLE”) approach. The choice of the distribution of ε, and consequently, of the regression model, may be a function of the comprehensive coverage of the survey questions. For example, if there are latent variables (i.e., variables that affect the purchasing decision but that are not addressed by any of the survey questions), then a linear probability model may be appropriate, because this type of model converges in probability to the true value of the parameter in the population.

The models produced for each cluster are indicated at 135 as a corresponding set of models 1, 2, . . . n. At 140, projected purchasing decision responses for the clusters may be generated, for example by a computer, by using each cluster's corresponding model. As noted above, in the survey (or surveys) considered, some of the product attribute questions may relate to control variables. Some embodiments use the models to evaluate one or more alternative scenarios of interest by setting or changing a value of one or more control variables and assessing the effect of the change on, for example, purchasing decisions. Projected purchasing decision responses may be generated by replacing values corresponding to control variables, with alternative values. This may be done by producing a new matrix X′ by replacing values of selected elements x of matrix X with new values, and calculating new vector y′ as follows;

y′ᵢ=β′X′

Each vector y′ᵢ represents the projected purchasing decision regarding the product i. Element j of vector y′ᵢ corresponds to respondent is projected purchasing decision response at the new variable value.

In the illustrative example of a computer game, a control variable may be the price of the product. To explore a scenario in which the computer game is sold at a price of $25, new matrix X′ is created from X by replacing the column vector corresponding to responses to the question “How much do you usually pay for video games'?” by a column vector with all elements having a uniform value of 25. The projected purchasing decisions, for each cluster, for a computer game at this price are represented by the vector y′ᵢ.

Product price is only one example of a control variable. Other examples include variables related to various features of product (for example, size, type, additional items included such as a warranty or a promotional item, and so forth) features of other marketing tools such for the product such as a product or store website, and so forth.

At 140, the process proceeds by transforming the initial customer survey response data by replacing the purchasing decision data representing actual purchasing decision responses with the projected purchasing decision responses. The output of this procedure is indicated at box 145. Product attribute data 115 is transformed, indicated at 150, and respondent attribute data 110 remains unchanged.

At 155, survey respondents are re-clustered, by identifying a data pattern in the transformed data represented by box 145. Again, the clustering may be hard or soft. The responses selected for the re-clustering process excludes those related to control variables, and in some methods may include only behavioral data. For example, considering only the purchasing decision responses may result in a pattern based only on purchasing behaviors, whereas considering behavioral responses for re-clustering may identify patterns indicative of how, and to what extent, such factors impact purchasing decisions.

The output of the second clustering process is shown at 160 as a set of clusters 1, 2, . . . m. The results of the second clustering process may be thought of as a fictitious data set representing the customers (or types of customers) who are predicted to purchase the product in question in an alternative scenario being considered; that is, with the value of one or more control variables set at a desired value. In the illustrative example of a computer game, the results of the second clustering may predict the customers, such as customers associated with an identified behavioral and/or demographic characteristic, who will buy a computer game at a target price, such as a price of $25 or some other value.

At 165, cluster shift between the first and second sets of clusters (125, 160) may be analyzed. The analysis may take any of a variety of forms, depending on the inquiry. For example, re-clustering based on the same behavioral factor as in the illustrated example above, i.e., based on responses to the question “What kind of TV programs do you usually watch?”, may allow a marketer to forecast whether a particular TV program audience would be more or less likely to purchase a computer game at the new price in the scenario of interest, or may indicate other correlations between TV program preference and willingness to purchase a computer game at various price point.

In general, comparison of outcomes obtained for different scenarios of interest allow marketer or analysts to assess the robustness of the clusters with respect to the control variables. For example, the marketer may be interested in determining the extent of cluster change, if a product price is set at different values. The analysis may allow a marketer to distinguish preference driven purchasing behaviors and price driven purchasing behaviors.

The example method 200 shown in FIG. 2 is illustrated as a flow chart in which several of the above-described procedures are performed, for example by a computer or a computer network. The example method thus includes, at 210, clustering survey respondents, for example according to a data pattern identified in a dataset of responses to survey questions including a question regarding a product purchasing decision, and questions regarding respondent attributes and product attributes. As noted above, the respondent attribute responses may include demographic responses and behavioral responses, and the data pattern used for clustering may be identified in the data corresponding to behavioral responses, such as a common response to a selected question. Also, one or more of the product attributes may relate to control variables, such that the data pattern identified in the data set is based on a subset of responses to respondent attribute questions exclusive of survey questions endogenously linked to the control variable. Clustering may be performed as hard clustering, in which each respondent is associated to exactly one cluster, or soft clustering, in which each respondent is associated to a probability distribution across two or more clusters.

At 220, the example method includes producing, from data associated with a given cluster, a model relating purchasing decision responses to product attribute responses, or to product attribute responses together with demographic responses. Producing a model may include performing a regression analysis on the data associated with the given cluster. The method may include producing a model for each cluster in this manner.

At 230, the example method includes generating, using each model, projected purchasing decision responses for the corresponding cluster by replacing a value relating to a response to a selected product attribute question with an alternative value. The selected product attribute question may relate to a control variable, such as product price, such that replacing the value relating to the selected question represents setting the control variable at a set value. At 240, the example method includes transforming the dataset by replacing purchasing decision responses with the projected responses generated by using the models. At 250, the example method includes re-clustering the survey respondents, and at 260, the example method includes analyzing cluster shift.

The example system 300 in FIG. 3 is shown as a block diagram that includes a data storage subsystem 310 in communication with a processing subsystem 320. Data storage subsystem may be configured to store a dataset 330 of customer survey response data. As noted above, the dataset may include data representing product attribute responses and data representing respondent attribute responses, indicated in FIG. 3 at 340 and 350, respectively.

The data 330 stored and managed in the data processing subsystem 310 may be available to the processing subsystem 320, which may be configured to perform various steps of the example method 200 disclosed above. For example, the processing subsystem may be configured to cluster survey respondents according to a selected data pattern in the dataset, produce from each cluster's associated data a model relating purchasing decision responses to product attribute responses, use the model to project purchasing decision responses for the cluster, transform the dataset by replacing purchasing decision responses with the projected responses, and re-cluster survey respondents according to a selected data pattern in the transformed dataset. In some embodiments, the system 300 may incorporate one or more components and/or subcomponents to perform one or more of such steps. For example, processing subsystem 320 is shown to include a clustering module 360 that clusters survey respondents according to a selected data pattern in the dataset, a model producer 365 that produces, from data associated with a given cluster, a model relating purchasing decision responses to product attribute responses, a generator 370 that uses the model to generate projected purchasing decision responses for the cluster, such as by replacing a value relating to a response to a selected product attribute question that relates to a control variable with an alternative value that relates to a predetermined value of the control variable, a data transformer 375 that transforms the dataset by replacing purchasing decision responses with the projected responses, and a re-clustering module 380 that re-clusters survey respondents according to a selected data pattern in the transformed dataset. In some embodiments, these components may be thought of as collectively forming an apparatus 400 for evaluating a workforce plan using the dataset 330. Apparatus 400 may be a computer, or a computer network, and may physically house the components and subsystems of system 300, as shown in FIG. 3. For example, a computer may include at least one computer readable storage medium, such as a memory, and a processor operatively connected to the memory. The storage medium may carry data and instructions for operating on the data, or may take any suitable configuration.

In addition to providing a marketer with results that may isolate effects from (and perhaps draw correlations regarding) selected factors other than past purchasing behavior, the example process and method discussed above may assist the marketer in devising marketing campaigns. For example, if the price of a product is going to be reduced, the regression outputs may allow a marketer to identify customers who are most likely to buy (i.e., those for which y′ is different from y) because of the price change. The process may also enable a marketer to re-use results of a survey that was conducted under a given set of environmental conditions to predict customer behavior under new conditions, which may reduce the cost associated with conducting additional customer surveys.

We claim:

1. A method, comprising:
clustering (210) survey respondents into two or more clusters according to a data pattern identified in a dataset of responses to survey questions that includes product purchasing decision response data, and respondent and product attribute response data;
producing (220), by a computer, from data associated with a given cluster of the two or more clusters, a model relating purchasing decision response data to product attribute response data;
generating (230), by a computer using the model, projected purchasing decision response data for the cluster by replacing a value relating to selected product attribute data with an alternative value;
transforming (240) the dataset by replacing purchasing decision response data with the projected purchasing decision response data and
re-clustering (250) survey respondents according to a data pattern identified in the transformed dataset.

2. The method of claim 1, wherein the respondent attribute response data includes demographic response data and behavioral response data.

3. The method of claim 2, wherein the data pattern for clustering is identified in the behavioral response data.

4. The method of claim 2, wherein the model relates purchasing decision response data to product attribute response data and demographic response data.

5. The method of claim 1 wherein the survey questions include at least one product attribute survey question that relates to a control variable.

6. The method of claim 5, wherein the data pattern identified in the data set is based on a subset of the respondent attribute question response data exclusive of survey questions endogenously linked to the control variable.

7. The method of claim 1, further comprising, subsequent to re-clustering (250) survey respondents, analyzing (260) cluster shift.

8. The method of claim 1, wherein clustering associates each respondent to exactly one cluster.

9. The method of claim 1, wherein clustering associates each respondent to a probability distribution across the two or more clusters.

10. The method of claim 1, wherein the survey questions include at least one respondent attribute survey question, and wherein the data pattern relates to a common response to a selected one of the at least one respondent attribute survey question.

11. The method of claim 10, wherein the survey questions include at least one product attribute survey question that relates to a control variable, and wherein the selected respondent attribute survey question is non-endogenous with respect to the control variable.

12. The method of claim 1, wherein producing a model includes performing a regression analysis on the data associated with the given cluster.

13. The method of claim 1, wherein producing a model is performed for each cluster, such that two or more models are produced, and wherein generating projected purchasing decision responses is performed for each model.

14. An apparatus (400) for eliciting customer preference from purchasing behavior surveys using a dataset (330) of customer survey response data including data (340) representing product attribute responses and data (350) representing respondent attribute responses, comprising:
a clustering module (360) that clusters survey respondents according to a selected data pattern in a dataset representing responses to survey questions that include a question regarding a product purchasing decision, and questions regarding respondent attributes and product attributes;
a model producer (365) that produces, from data associated with a given duster, a model relating purchasing decision responses to product attribute responses;
a generator (370) that uses the model to generate projected purchasing decision responses for the duster by replacing a value relating to a response to a selected product attribute question that relates to a control variable with an alternative value that relates to a predetermined value of the control variable;
a data transformer (375) that transforms the dataset by replacing purchasing decision responses with the projected responses; and
a re-clustering module (380) that re-clusters survey respondents according to a selected data pattern in the transformed dataset.

15. A system of eliciting customer preference from purchasing behavior surveys, comprising:
a data storage subsystem (310) configured to store a dataset (330) of customer survey response data including data (340) representing product attribute responses and data (350) representing respondent attribute responses;
a processing subsystem (320) in communication with the data storage subsystem (310) and configured to:
cluster (210) survey respondents into clusters according to a selected data pattern in the dataset (330);
produce (220), from data associated with a given cluster, a model relating purchasing decision responses to product attribute responses;
generate (230), using the model, projected purchasing decision responses for the cluster by replacing a value relating to a response to a selected product attribute question with an alternative value;
transform (240) the dataset (330) by replacing purchasing decision responses with the projected responses; and
re-cluster (250) survey respondents according to a selected data pattern in the transformed dataset.
